(19) United States
(12) Patent Application Publication
(10) Pub. No.: US 2008/0126487 A1
(43) Pub. Date: May 29, 2008

(54) Method and System for Remote Collaboration

(76) Inventors: Rainer Wegenkittl, Sankt Poelten (AT); Donald K. Dennison, Waterloo (CA); John J. Potwarka, Waterloo (CA); Lukas Mroz, Wien (AT); Armin Kanitsar, Wien (AT); Gunter Zeilinger, Wien (AT)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/944,213

(22) Filed: Nov. 21, 2007

Related U.S. Application Data
(60) Provisional application No. 60/867,066, filed on Nov. 22, 2006.

(51) Int. Cl. G06F 15/16

(52) U.S. Cl. 709/205

(57) ABSTRACT

A collaboration method and system where a first workstation participates in a collaboration session with one or more other workstations. Firstly, a first event message is received at the first workstation where the first event message includes information regarding an interaction with a displayed image at the one or more other workstations. Secondly, the first event message is analyzed to determine whether the interaction is to be executed at the first workstation upon a representation of the displayed image. If so, then the interaction is executed at the first workstation upon representation of the displayed image. If not, then the interaction is not executed at the first workstation and a second event message is received and analyzed.

### CROSS REFERENCE TO RELATED APPLICATION(S)

This application claims benefit of and priority to U.S. Provisional Application Ser. No. 60/867,066, filed Nov. 22, 2006. The entire disclosure of which is herein incorporated by reference.

### BACKGROUND

1. Field of the Invention

This invention relates generally to remote collaboration methods and systems, and more specifically to an improved method and system for remote collaboration when interacting with images.

2. Description of the Related Art

In medicine, when reviewing data associated with a patient, often multiple health care professionals will review data in order to formulate an accurate assessment of the patient's health. Where multiple people are involved in the analysis of data, the data is generally provided to multiple people at different times so that they may review the data and formulate an opinion. When dealing with medical images, health professionals typically review such medical images, provide their remarks, and provide the medical image to the next person for review.

With the advent of electronic medical image retrieval systems, health professionals are able to access medical images from selected work stations. Where collaboration is required, often the health professionals will review the medical images electronically and provide their remarks in an electronic format that allows for access to the next health professional. Alternatively, where multiple health professionals are required to review medical images, the health professionals may attempt to gather in one place and view the medical image at the same time, so that their experiences and comments may be shared with one another.

However, as health professionals, due to reasons of time and proximity, may not be able to gather in one place, methods and systems have been proposed that allow for remote collaboration where the respective health professionals engage in a collaboration session where they access the medical image that is resident upon a remote device. The collaboration session allows one or more users to engage with the medical image and perform manipulations and transformations of the image that are then shown to the other health professionals upon their respective stations.

When health professionals engage in an interactive collaboration session, one of the major limitations is the processing speed associated with the workstations that are engaging in the collaboration session. At the workstation level, slower processors can cause some users to lag behind others with respect to the ability to view an accurate representation of a medical image that is being manipulated by another user. If the view of a medical image that is being shown to a user begins to lag, the collaboration session becomes inefficient as some users are not able to participate effectively.

### SUMMARY

The embodiments described herein provide in one aspect a collaboration method wherein a first workstation participates in a collaboration session with one or more other workstations, said method comprising: (a) receiving a first event message at the first workstation wherein the first event message comprises information regarding an interaction with a displayed image at the one or more other workstations; (b) analyzing the first event message to determine whether the interaction is to be executed at the first workstation upon a representation of the displayed image; (c) if (b) is true, executing the interaction upon the representation of the displayed image; and (d) if (b) is false, skipping executing the interaction upon the representation of the displayed image and receiving a second event message and analyzing the second event message.

The embodiments described herein provide in another aspect a collaboration method wherein a first workstation participates in a collaboration session with one or more other workstations, said method comprising: (a) receiving a first event message at a relay server wherein the first event message comprises information regarding an interaction with a displayed image at the one or more other workstations; (b) analyzing the first event message to determine whether the interaction is to be executed at the first workstation upon a representation of the displayed image; (c) if (b) is true, executing the interaction upon the representation of the displayed image at the first workstation; and (d) if (b) is false, skipping executing the interaction upon the representation of the displayed image and receiving a second event message at the image server and analyzing the second event message.

The embodiments described herein provide in another aspect a collaboration system having a first workstation that participates in a collaboration session with one or more other workstations, the system comprising: (a) a memory for storing a plurality of instructions; and (b) a processor coupled to the memory, said processor configured for: (i) receiving a first event message wherein the first event message comprises information regarding an interaction with a displayed image at the one or more other workstations; (ii) analyzing the first event message to determine whether the interaction is to be executed at the first workstation upon a representation of the displayed image; (iii) if (ii) is true, executing the interaction upon the representation of the displayed image; and (iv) if (ii) is false, skipping executing the interaction upon the representation of the displayed image and receiving a second event message and analyzing the second event message.

Further aspects and advantages of the embodiments described will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an exemplary embodiment of a collaboration system;

FIG. 2 is a flowchart diagram illustrating the basic operational steps executed by the collaboration system of FIG. 1;

FIG. 3 is a block diagram illustrating the components of the event message of FIG. 1;

FIG. 4 is a block diagram illustrating the components of the event engine of FIG. 1; and

FIG. 5 is a flowchart diagram illustrating in more detail the operational steps executed by the collaboration system of FIG. 1.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The embodiments of the systems and methods described herein may be implemented in hardware or software, or a combination of both. However, preferably, these embodiments are implemented in computer programs executing on programmable computers, each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer-usable instructions for one or more processors. The medium may be provided in various forms including one or more diskettes, compact disks, tapes, chips, wireline transmissions, satellite transmissions, internet transmission or downloadings, magnetic and electronic storage media, digital and analog signals, and the like. The computer-usable instructions may also be in various forms including compiled and non-compiled code.

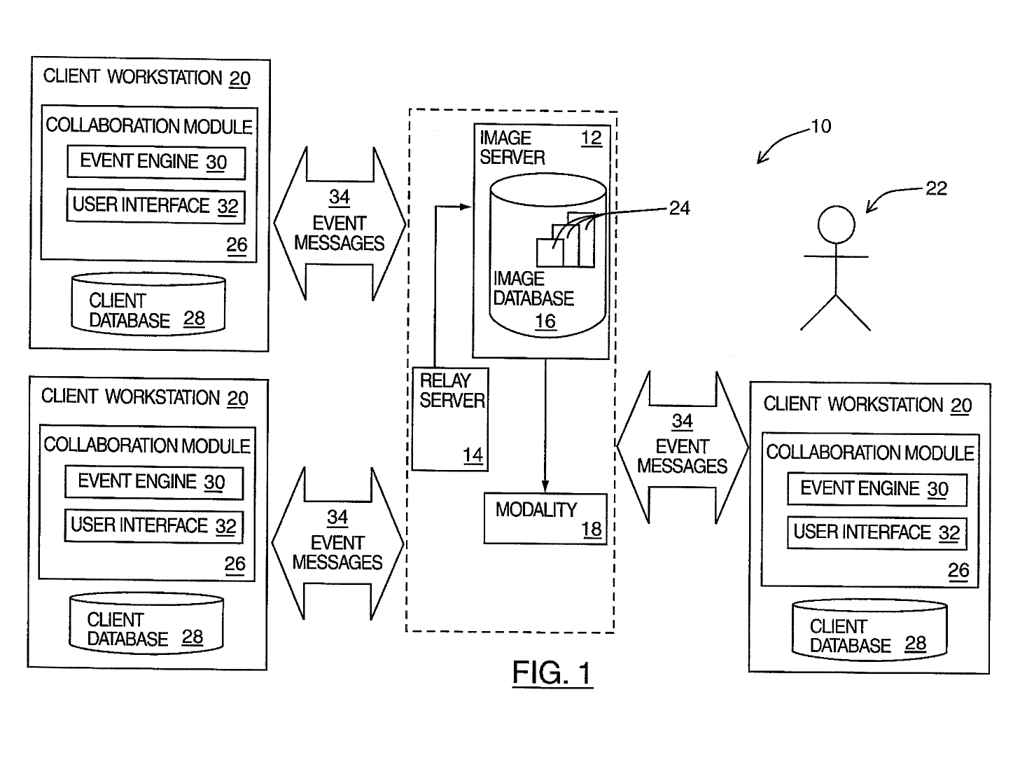

Reference is now made to FIG. 1 which illustrates elements of an exemplary embodiment of a collaboration system 10. The collaboration system 10 includes an image server 12, a relay server 14, an image database 16 that stores medical images 24, an imaging modality 18 and one or more client workstations 20. The collaboration system 10 allows users 22 of the client workstations 20 to engage in a collaboration session with one or more other users 22 who have their client workstations 20 connected to the image server 12. The collaboration session allows users 22 to view and manipulate a document or file, which in an exemplary embodiment is described with respect to a medical image 24 upon their respective client station 20. Each manipulation of the medical image 24 by any of the users 22 of the session is transmitted to all of the other client workstations 20, so that all of the users 22 are able to view the results of the manipulations being performed by the other users 22. The system 10 ensures that the client workstations 20 that are part of the collaboration session are synchronized with respect to the views of the medical images 24 that are shown on each client workstation 20.

As discussed in more detail elsewhere, it should be understood that the image collaboration system 10 may be implemented in hardware or software or a combination of both. Specifically, the modules of image collaboration system 10 are preferably implemented in computer programs executing on programmable computers, each comprising at least one processor, a data storage system, at least one input device and at least one output device. Without limitation, the programmable computers may be a mainframe computer, server, personal computer, laptop, personal data assistant or cellular telephone. In an exemplary implementation, image collaboration system 10 is implemented in software and installed on the hard drive of client workstation 20 and on image server 12, such that the client workstation 20 interoperates with image server 12 in a client-server configuration.

The image server 12 stores medical images 24 in the image database 16. The image server 12 in an exemplary embodiment receives medical image data (e.g. DICOM images, bitmaps, JPEGS, GIFs, etc) from the imaging modality 18. The imaging modality 18 generates the medical image data based on various procedures that may be performed on patients and provides the medical image data that forms the medical image 24 to the image server 10. The image server 10 is connected through the communication network by wired or wireless methods to the client workstations 20. The client workstations 20 connect to the image server 10 through a communication network and access the medical images 24 that are stored upon the image database 16.

The relay server 14 receives requests for medical images 16 from the client workstations 20, processes the requests and provides the respective medical images to the client workstations 20. The relay server 14 acts as a distributor to ensure that information regarding the various manipulations that are being performed on the medical image 24 upon the one or more client workstations 20 are distributed to all of the client workstations 20 that are part of the collaboration. The relay server 14, to the client workstations 20 that interact with it, appears to be another client workstation 20. The relay server 14 and the collaboration module 26, as explained below, ensure that all of the user workstations 22 that are part of a collaboration session are synchronized.

The interactions and transformations that are performed upon a medical image 26 at a client workstation 20 are referred to herein as manipulations. The manipulations performed at any of the client workstations 20 that are part of the collaboration are propagated through the relay server 14 to all of the client workstations 20 such that each of the users 22, contemporaneously, have the same view of the medical image 24 provided to them, and to ensure that all of the views of the image 24 are synchronized. Though the relay server 14 and image server 12 have been shown as two separate components, it should be understood that the functions served by both respective servers, may be accomplished on the same computing device.

The image database 16 is used to store the medical image data that is then converted into medical images. The image database 16 stores both the permanent and temporary versions of medical images 24. The image database 16 also stores associated identification information with respect to each medical image 24. For example, medical images may have associated with them patient identifiers, patient names, and other descriptions regarding the patient, image, or study from which the medical images 24 were generated.

The imaging modality 18 generates medical image data in either an analog or digital format from which the medical images 24 are created. The imaging modality 18 may include any device that is used to capture any type of image of a patient. The medical images 24 that are generated by the imaging modality are stored in the image database 16.

Each client workstation 20 may be any computing device that is able to connect to the image server 10. Examples of client workstations 20, include, but are not limited to, personal computers, laptop computers, slim line computers, server based computers, handheld computers and any other such device that is able to provide an interface and connect to the image server 10 through a communication network. The users 22 of the client workstations 20 may be any users who engage the client workstation 20 for purposes of taking part in a collaboration session. Each client workstation 20 has an output device (not shown) such as a monitor or screen associated with it along with one or more input devices.

Each of the client workstations 20 that are part of the system 10, include a collaboration module 26 and a client storage area or database 28. The collaboration module 26 is comprised of an event engine 30 and a graphical interface 32.

The event engine 30 stores a series of events that are to be executed and determines, as explained below, which events are to be executed such that all of the client workstations 20 may remain in a state of synchronization. The events that are received at the event engine 30 represent the manipulations that have been performed on the medical image 24 by other users 22 at the respective client workstations 20. The operation of the event engine 30 and its constituent components in an exemplary embodiment are described in further detail below.

The graphical user interface 32 is an interface displayed upon the output device associated with the workstation 20. The graphical user interface 32 provides the users with various visual icons that the users may engage with when taking part in a collaboration session. The graphical user interface 32 is engaged through use of the one or more input devices where the user 22 performs manipulations upon the medical image through use of a mouse in combination with a keyboard in a preferred embodiment.

Through use of the functionality provided upon the graphical user interface 32 displayed, the user 22 is able to perform various manipulations of the medical image 24. In a preferred embodiment, the medical image 24 is initially retrieved from the image server 10. The image 24 is retrieved based on the establishment of a communication session based on a communication protocol between the respective client workstation 20 and server 12. In an exemplary embodiment, this communication session may be based on an http session or a secure https session. A temporary copy of the medical image 24 that is retrieved from the image server 12 may be stored within the client storage area 28. In an exemplary embodiment, the client storage area 28 is cache memory that is used to the image 24. In alternative embodiments, the medical image 24 that is to viewed and interacted with as part of the collaboration session may be stored at the client storage area 28 and copies of the image 24 may be propagated to the other client workstations 20 that are part of the collaboration session.

Once a collaboration session has been established, multiple users 22 may take part in the collaboration session. More than one user 22 may engage the medical image 24 and perform manipulations of the medical image wherein the manipulations are then propagated to all of the client workstations 20 that are part of the session. The collaboration system 10 ensures that there is synchronization of all of the image views upon all of the user workstations 20, even when multiple users 22 are manipulating the medical image 24 on their own workstation 20.

When a user 22 engages the medical image through the user interface, the user 22 is able to perform various manipulations and interactions with the medical image 24. The various manipulations that may be performed include, but are not limited to, rotations, zooming, displacing (moving), shading, highlighting, and any other interaction that a user may perform upon a medical image 24 that is presented on their display.

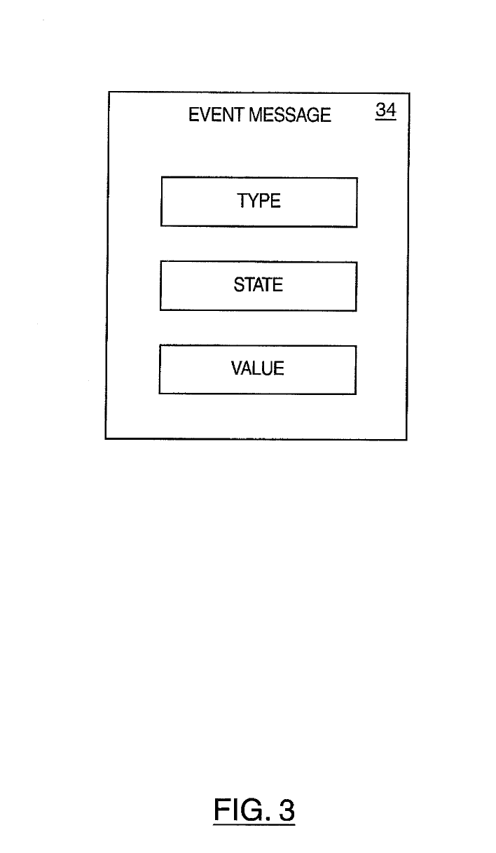

One or more event messages 34 are generated by the collaboration module 26 each time the user 22 performs a manipulation of the medical image 24. The event message 34 is described in further detail with respect to FIG. 3. The event message 34 is sent from the respective workstation 20 where the medical image is being manipulated to the image server 12 and more specifically to the relay server 14 and onwards to all of the respective client workstations 20 that are part of the session. The event message 34, when received at the client workstations 20, is processed by the event engine 30, as described below.

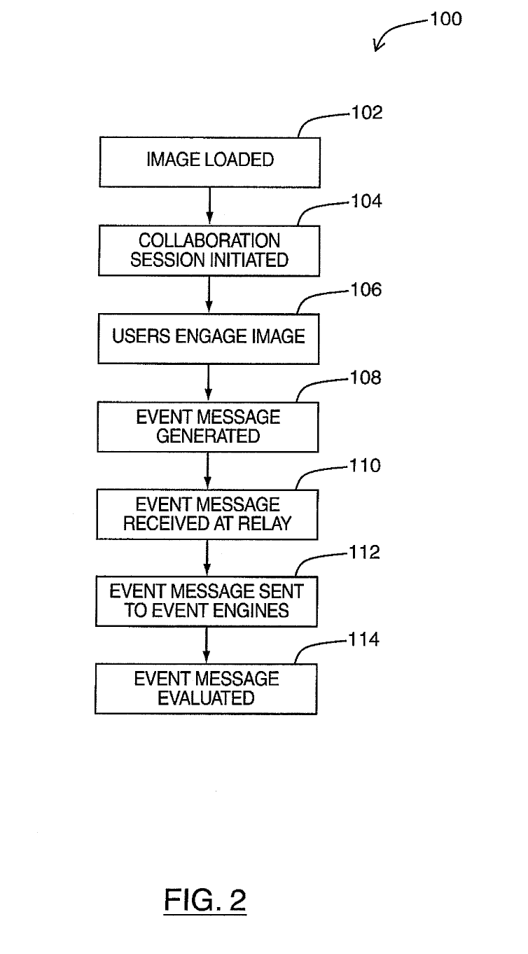

Reference is now made to FIG. 2, where a flowchart illustrates the basic operational steps 100 of the collaboration system 10. Operation 100 begins at step (102) where a user engages the graphical user interface 32 upon their respective workstation 20. The user may open the interface 32 to join or initiate a collaboration session. At step (102), the user loads a medical image 24 from the image server 12 into the interface 32. The medical image 24 may be loaded by specifying the location where the respective medical image 24 file is found. In alternative embodiments, the medical image 26 may be stored upon the client database 28 that is found upon the user workstation 20.

At step (104), the collaboration session is initiated where other users 24 may join the session. When other users 22 join the collaboration session, a temporary copy of the medical image 24 is copied and downloaded by the client workstation 20. The representation of the medical image 24 that reflects the current state of the collaboration session is provided by one of the existing client workstations 20 that are part of the collaboration sessions. Each client workstation 20 is able to provide the representation of the medical image 24 to a new client workstation that has joined the session, as each client workstation has a medical image that reflects the current state of the collaboration session.

At step (106), one or more users 22 who are taking part in the collaboration session may engage the medical image 24 and perform one or more interactions on the image. Multiple users 22 of the session may perform manipulations of the image 24 where the manipulations are propagated to all of the workstations 20.

At step (108), upon a user performing a manipulation of an image upon their respective workstation 20, event engine 30 generates an event message 34. The event message 34 communicates details regarding the manipulation of the medical image 24 to the relay server 14. At step (110), the relay server 14 receives the event message 34. For every manipulation that is performed upon a medical image (i.e. a zoom), multiple event messages 34 are generated and sent to the relay station. Also, as more than one workstation 20 may be manipulating the image 26, the relay server 14 may receive event messages from multiple workstations 20 at the same time. The relay server 14 handles all of the event messages it receives.

At step (112), the relay server 14 transmits the event message 34 to the other client workstations 20 that are members of the collaboration session. At step (112), the event engines 30 of the respective client workstations 20 receive the event message 34 and place it in a queue for processing.

At step (114), each event engine 30 of the respective workstations 20 evaluates the event message 34 to determine whether the event message 34 will be processed. Each event engine 30 processes the event message 34 to determine whether the event (manipulation) will be implemented upon the representation of the medical image 24 at the respective workstation 20 or whether execution of the event will be skipped. As each client workstation 20 that is part of the collaboration session may have varying hardware components, thus resulting in differing processing times, the slowest client workstation 20 that is part of a collaboration session may lag behind the other workstations with respect to the state of the image that is being displayed.

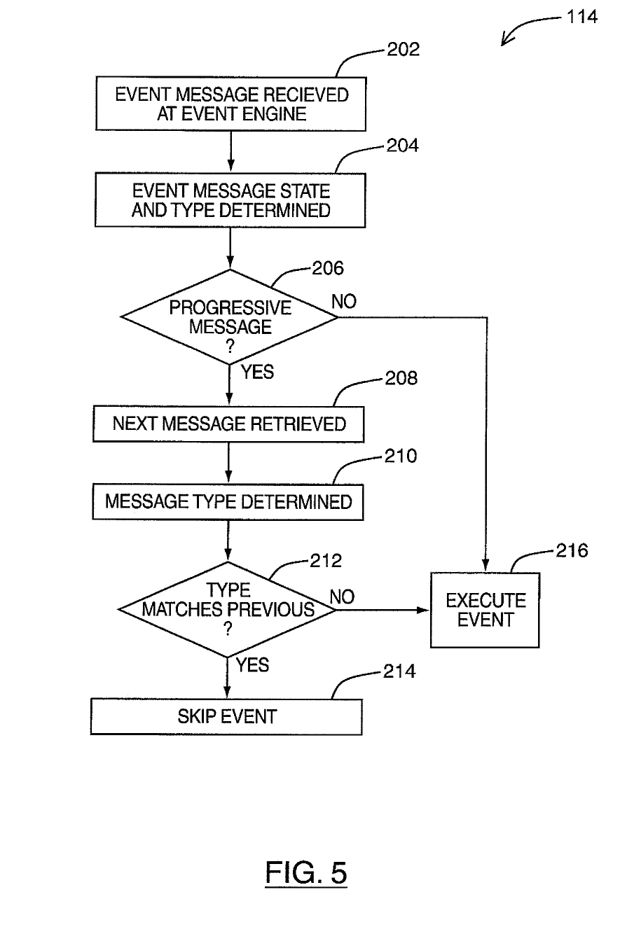

By having the event engine 30 determine which event message 34 to skip with respect to execution at a specific workstation 20, this can ensure that the state of the representation of the image 24 as displayed across all of the client workstations 20 that are part of a session is synchronized. Where events are not executed or skipped, the user 22 does not discern any difference when viewing the medical image upon their workstation 20. Therefore, workstations 20, which may be of varying speeds are able to maintain levels of synchronization, as detailed below. The method by which the synchronization process is executed is described further with respect to FIG. 5.

Reference is now made to FIG. 3 where an event message 34 is further described. During each manipulation of the medical image 24, multiple event messages 34 may be generated. For example, when a user 22 begins a rotation upon the image, an event message 34 is generated at the start of the rotation, during the rotation and upon the conclusion of the rotation. As some interactions with the client workstation 20 should not be propagated to other client workstations 20 (for example, logging out, printing, saving), the event engine 30 may operate in various modes. When operating in what is referred to as an “internal” mode (based on certain interactions), the event messages 34 that are generated are not propagated to the other client workstations 20. The specification of an event message being an internal mode is made in an exemplary embodiment at the sending workstation.

By generating and transmitting event messages 34 from the workstation 20 to all of the workstations 20 that are part of the collaboration session, the need to transmit the actual image upon which manipulations have been performed to all of the workstations of the collaboration session is eliminated. By not transmitting the actual image each time a manipulation is performed, the processing time associated with the overall system 10 is reduced, as workstations 20 operate upon their own representations of the image 24.

The event message 34 that is generated specifies the type of interaction or manipulation that is taking place upon the image. The types of events include, but are not limited to, zooming, rotation, displacement, and highlighting. Each interaction that takes place upon a medical image 24 may have varying states where, at the initiation of the interaction, the interaction is said to be in a start state.

During an interaction, for example, when the user continues to zoom in to an area upon the image 24 or continues to rotate an image 24, the state of interaction may be said to be a progressive, or continuous state, indicating that the interaction or specific manipulation is continuing and has not terminated. At the termination or end of an interaction, for example, when the rotation of the image is complete with respect to the users commands (i.e. the user has released the mouse key that was causing the rotation), the state of the interaction is terminated, or at an “end”.

Various other states may be used to describe the state of the interaction for which event messages are being generated and the examples provided here have been provided for purposes of description.

The value field that is part of the event message indicates a value that is used to execute an event when applicable. As an example, the values may represent the co-ordinate measurements (the displacement co-ordinates in the respective, x, y and z (where applicable) co-ordinates, the zoom factor, or other applicable co-ordinate/value measurements that allow for the manipulation to be executed.

The value field allows for other workstations 20 to correctly carry out the manipulation upon their respective workstation 20. As an example, during an interaction such as a zoom function, multiple event messages are generated by the event engine 30. The first event message indicates that an interaction or manipulation has begun and the subsequent event messages provide updates with respect to the state of the manipulation (i.e. when the zooming is continuing). The last event message for an interaction is generated upon termination of the interaction. Various other parameters may also be associated with the event message 34 that are used to synchronize the execution of such event messages 34 at the respective workstations 20 and are described in detail below.

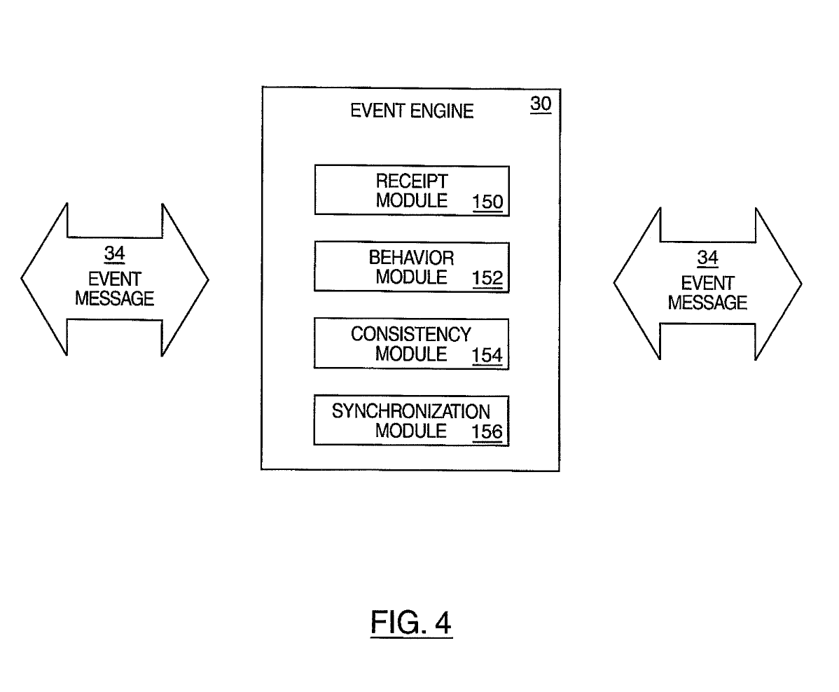

The handling of event messages is now described with respect to a description of the event engine 30. The event engine 30, as described above, is resident upon or associated with each workstation 20 that is a member of the system 10. Reference is now made to FIG. 4, where the components of the event engine 30 are described in further detail. The event engine in an exemplary embodiment comprises a receipt module 150, behavior module 152, a consistency module 154 and a synchronization module 156. Every event message 34 that is generated at the client workstation 20 is generated by the event engine 30 associated with that workstation 20.

The receipt module 150 ensures that the event messages are transmitted to all of the client workstations 20 that are part of a session and ensures that the messages are transmitted only once and not unnecessarily re-sent. The messages 34 from the event engine are sent to the relay server 14 where they are then sent to respective event engines 30 associated with the other workstations.

The behavior module 154 is used to determine whether the respective event engines 30 have received the event message 34. The consistency module 156 and the synchronization module 158 ensure that the event messages 34 that are generated are processed at the receiving workstations 20 in a specific order.

The event messages 34 that are generated may have one or more parameters associated with them that allow for the workstations 20 of the system 10 to remain synchronized. Examples of such event messages are provided below and they may include, but are not limited to, ordered messages, streaming messages, exclusive messages, flushing messages, and blocking messages.

The event messages 34 that are generated may have one or more parameters associated with them that indicate that they are part of an ordered sequence. An event message 34 that has a parameter indicating an order associated with it indicates that the specific event message 34 should be executed only after the previous event messages 34 of the same ordered sequence have been executed and before the processing of any other event messages 34. For example, when a user is performing a rotation, the event messages are generated in an ordered sequence.

Another parameter associated with the event messages 34 may indicate that the event message is part of a streamed interaction. Where event messages 34 are part of a streamed interaction, the processing of such event messages 34 is not undertaken until event messages that may belong to a previous streamed interaction have been completed.

The event message 34 may also have associated with it a parameter indicating that the event message 34 is an exclusive message. An exclusive message indicates that all of the recipients of the exclusive message must have received the message and processed the event messages 34 of a specific interaction before the processing of the exclusive event message 34.

The event message 34 may also have associated with it a parameter indicating that the event message is a flushing message. A flushing message indicates that all of the previous event messages 34 must have been processed before the execution of the flushing event message 34.

When an event message 34 has associated with it a parameter indicating that it is a blocking event message, this results in blocking the processing of other event messages 34 and processing the blocking event message. The blocking event message 34 is sent where synchronous execution of an interaction upon the representative image is required at all the other workstations 20 that are part of the system 10. For example, blocking event messages may be sent where a screen layout is charged, where the charged layout must be replicated at all the other stations.

The various parameters that have been described above in association with an event message 34 that allow for synchronization may also be combined, depending on the synchronization requirements.

Reference is now made to FIG. 5, where a flowchart illustrating in more detail the operational steps of the image collaboration system 10, and in particular more detail associated with the process step (114). The processing as described herein is described with respect to the processing that is undertaken at one specific workstation and more specifically by the event engine 30 at one specific station. It should be understood that in the system 10, the workstations 20 and their respective event engines 30 are operating concurrently to ensure synchronization, and contemporaneous views of the images upon all of the workstations.

At step (202), the event message 34 is received at the event engine 30 of all of the client workstations 20. The event engine 30, when it receives the event message 34 at the user workstations 20, has the event message entered into a queue. The event engine 30 is not aware that the event message that has been placed in the queue has not originated at the respective workstation 20.

At step (204), the event message 34 that is in the queue is analyzed. Specifically, at step (200) the message is analyzed to determine the state of the event. As the stages in an exemplary embodiment may be at a start stage, a progressive or continuous stage or a termination state, the state of the event is determined.

At step (206), a check is performed to determine whether the state is a progressive or continuous state, along with the type of event. If the check at step (206) determines that the stage of the respective event message 34 is not progressive, meaning that the event message is either indicating the start or end of a respective manipulation, at step (216) the event message has its respective event (type) executed upon a representation of the image 24 according to the information that is stored in the event message 34. As the event message 34 specifies the type of message and value information that will allow for the execution, the event is executed and the changes are thus reflected upon the medical image 24 that is displayed at the respective workstation 20.

If the check at step (206) determines that the stage of the event is a progressive or continuous event, at step (208), the next message in the queue is retrieved. At step (210), the event message 34 is analyzed to determine the type of event. At step (212), a check is performed to determine whether the type of event matches the type of event for the previous message, as determined at step (204). For example, if the current event type is a rotation and the previous event type of the previous event message was a rotation, then at step (214), the execution of the event message as analyzed at step (204) may be skipped, where the processing speed of the workstation does not allow for the workstation to keep up with the processing of all the events that are being received.

If, at step (212), it is determined that the type of the events do not match, then the event message that was analyzed at step (204), even though it has been marked as having a progressive or continuous state, is executed at step (216). By skipping the execution of certain progressive events, the client workstation is able to maintain synchronization with the other workstation while, at the same time, providing the user with an accurate representation of the medical image that is being manipulated, thereby ensuring a level of synchronization between the workstations. The user 22 of the workstation 20 that has skipped the execution of certain events will not notice a discernable difference when viewing the respective image. For example, taking a zoom function, when a user 22 is zooming in upon a medical image 24, an event message 34 with a start state is generated, along with multiple messages with progressive states (as the zooming continues). Also, further processing may be undertaken to analyze events that do not need to be executed based on what information they will provide to users of other workstations. When it is determined that the users of the workstations will not receive any benefit from viewing the manipulations, those manipulations are not propagated to all of the other workstations. An algorithm searches for such events, for example, when a user of a sending workstation has rotated an image and then rotates the image-ball immediately to its original position, this may be skipped. The event messages with progressive states may be skipped and the final zooming event message 34 with a termination state is then executed.

In order to allow for synchronization, the image collaboration system 10, as described above, may skip all of the progressive state event messages with the exception of the last one. By skipping the progressive events, the computational complexity of the overall image collaboration system 10 is reduced as fewer events are executed. From the point of view of the user 22 who is using a workstation 20 at which certain events have been skipped, the user will not view the manipulation in a seamless format, as a frame rate of the user's display update is lower. However, this allows the workstations 20 to remain in synchronization. Upon the conclusion of a manipulation, all of the representative images at all of the workstations 20 will be identical.

While the various exemplary embodiments of the image collaboration system 10 have been described in the context of medical image management in order to provide an application-specific illustration, it should be understood that the image collaboration system 10 could also be adapted to any other type of image or document display system.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A collaboration method wherein a first workstation participates in a collaboration session with one or more other workstations, said method comprising:
(a) receiving a first event message at the first workstation wherein the first event message comprises information regarding an interaction with a displayed image at the one or more other workstations;
(b) analyzing the first event message to determine whether the interaction is to be executed at the first workstation upon a representation of the displayed image;
(c) if (b) is true, executing the interaction upon the representation of the displayed image; and
(d) if (b) is false, skipping executing the interaction upon the representation of the displayed image and receiving a second event message and analyzing the second event message.

2. The method of claim 1 wherein the first event message comprises information regarding a type of interaction and a state of interaction.

3. The method of claim 2 wherein the state of interaction may be selected from a group comprising a start state, a continuous state, or an end state.

4. The method of claim 3 wherein (b) is determined, based on analyzing the state of interaction to determine whether the state of interaction indicates a continuous state.

5. The method of claim 1 wherein multiple event messages are generated for the interaction with the displayed image.

6. The method of claim 1 wherein the first event message and the second event message are received at an event engine.

7. A computer-readable medium upon which a plurality of instructions are stored, the instructions for performing the steps of the method as claimed in claim 1.

8. A collaboration method wherein a first workstation participates in a collaboration session with one or more other workstations, said method comprising:
(a) receiving a first event message at a relay server wherein the first event message comprises information regarding an interaction with a displayed image at the one or more other workstations;
(b) analyzing the first event message to determine whether the interaction is to be executed at the first workstation upon a representation of the displayed image;
(c) if (b) is true, executing the interaction upon the representation of the displayed image at the first workstation; and
(d) if (b) is false, skipping executing the interaction upon the representation of the displayed image and receiving a second event message at the image server and analyzing the second event message.

9. The method of claim 8 wherein the first event message comprises information regarding a type of interaction and a state of interaction.

10. The method of claim 8 wherein the state of interaction may be selected from a group comprising a start state, a continuous state, or an end state.

11. The method of claim 8 wherein (b) is determined, based on analyzing the state of interaction to determine whether the state of interaction indicates a continuous state.

12. The method of claim 8 wherein multiple event messages are generated for the interaction with the displayed image.

13. A computer-readable medium upon which a plurality of instructions are stored, the instructions for performing the steps of the method as claimed in claim 8.

14. A collaboration system having a first workstation that participates in a collaboration session with one or more other workstations, the system comprising:
(a) a memory for storing a plurality of instructions; and
(b) a processor coupled to the memory, said processor configured for:
(i) receiving a first event message wherein the first event message comprises information regarding an interaction with a displayed image at the one or more other workstations;
(ii) analyzing the first event message to determine whether the interaction is to be executed at the first workstation upon a representation of the displayed image;
(iii) if (ii) is true, executing the interaction upon the representation of the displayed image; and
(iv) if (ii) is false, skipping executing the interaction upon the representation of the displayed image and receiving a second event message and analyzing the second event message.

15. The system of claim 14 wherein the first event message comprises information regarding a type of interaction and a state of interaction.

16. The system of claim 14 wherein the state of interaction may be selected from a group comprising a start state, a continuous state, or an end state.

17. The system of claim 14 wherein (ii) is determined, based on analyzing the state of interaction to determine whether the state of interaction indicates a continuous state.

18. The system of claim 14 wherein multiple event messages are generated for the interaction with the displayed image.

19. The system of claim 14 wherein the first event message and the second event message are received at an event engine.
